(19) United States
(12) Patent Application Publication
(10) Pub. No.: US 2014/0351550 A1
(43) Pub. Date: Nov. 27, 2014

(54) MEMORY MANAGEMENT APPARATUS AND METHOD FOR THREADS OF DATA DISTRIBUTION SERVICE MIDDLEWARE

(71) Applicant: ELECTRONICS AND TELECOMMUNICATIONS RESEARCH INSTITUTE, Daejeon-city (KR)

(72) Inventors: Hyung-Kook JUN, Seoul (KR); Jae-Hyuk KIM, Gunpo-si (KR); Soo-Hyung LEE, Daejeon (KR); Won-Tae KIM, Asan-si (KR)

(73) Assignee: ELECTRONICS AND TELECOMMUNICATIONS RESEARCH INSTITUTE, Daejeon-city (KR)

(21) Appl. No.: 13/951,925

(22) Filed: Jul. 26, 2013

(30) Foreign Application Priority Data
May 23, 2013 (KR) 10-2013-0058229

(51) Int. Cl. G06F 12/02

(52) U.S. Cl. CPC G06F 12/023
USPC 711/173

(57) ABSTRACT

Disclosed herein are a memory management apparatus and method for threads of Data Distribution Service middleware. The apparatus includes a memory area management unit, one or more thread heaps, and a queue. The memory area management unit partitions a memory chunk allocated for the DDS middleware by a Cyber-Physical System on a memory page basis, manages the partitioned memory pages, and allocates the partitioned memory pages to the threads of the DDS middleware that have requested memory. The thread heaps are provided with the memory pages allocated to threads of the DDS middleware by the memory area management unit, and manage the provided memory pages. The queue receives memory used pages returned by the thread heaps. The thread heaps are provided with the memory pages for the threads by the queue if a memory page is not present in the memory area management unit when the threads request memory.

### CROSS REFERENCE TO RELATED APPLICATION

This application claims the benefit of Korean Patent Application No. 10-2013-0058229, filed on May 23, 2013, which is hereby incorporated by reference in its entirety into this application.

### BACKGROUND

1. Field

The present invention relates generally to a memory management apparatus and method for the threads of Data Distribution Service (DDS) middleware and, more particularly, to a memory management apparatus and method for the threads of DDS middleware, which can partition memory allocated to the DDS middleware by a Cyber Physical System (CPS) on a memory page basis, allocate the partitioned memory to the threads of the DDS middleware, and allow memory pages used by threads to be used again.

2. Description of Related Art

A CPS is a system that guarantees software reliability, a real-time performance, and intelligence in order to prevent unexpected errors and situations from occurring because a real-world system is combined with a computing system and thus the complexity thereof increases. A CPS is a hybrid system in which a plurality of embedded systems have been combined with each other over a network, and has both the characteristic of a physical element and the characteristic of a computational element.

In a CPS, an embedded computer, a network, and a physical processor are mixed with each other, the embedded computer and the network monitor control the physical processor, and the physical processor receives the monitoring and control results of the embedded computer and the network as feedback and then exerts influences on the embedded computer and the network. In a CPS, a cyber system analyzes a physical system, causes the physical system to flexibly adapt to a change in a physical environment, and then reconfigures the physical system, thereby improving reliability. In particular, a CPS has a very complicated structure including many sensors, many actuators, and a processor. The sensors, the actuators, and the processor are connected together in order to exchange and distribute data therebetween.

Such a CPS requires data communication middleware that is responsible exclusively for data communication in order to distribute a large amount of data in real time with high reliability and low resources. Various types of data communication middleware, such as ORBA, JMS, RMI, and Web Service, have been developed as data communication middleware for the exchange of data. The conventional types of data communication middleware are based on a centralized method, and perform server-based data communication. In the server-based data communication middleware, if a server fails, the operation and performance of the entire data communication middleware system are highly influenced. Furthermore, the service-based data communication middleware has many problems with real-time performance and the transmission of a large amount of data due to a delay time because the middleware undergoes the processes of service searches, service requests, and result acquisition.

Since many problems may occur if the conventional data communication middleware technique is applied to a CPS, the Object Management Group (OMG), that is, an international software standardization organization, proposes a DDS middleware standard for efficient data transfer in a CPS. The DDS middleware proposed by the OMG provides a network communication environment in which a network data domain is dynamically formed and each embedded computer or a mobile device can freely participate in or withdraw from a network data domain. For this purpose, the DDS middleware provides a user with a publication and subscription environment so that data can be created, collected, and consumed without additional tasks for data that is desired by the user. The publisher/subscriber model of the DDS middleware virtually eliminates complicated network programming in a distributed application, and supports a mechanism superior to a basic publisher/subscriber model. The major advantages of an application using DDS middleware via communication reside in the fact that a very small design time is required to handle mutual responses and, in particular, applications do not need information about other participating applications including the positions or presence of the other participating applications.

Furthermore, DDS middleware allows a user to set Quality of Service (QoS) parameters, and describes methods that are used when a user sends or receives a message, such as an automatic discovery mechanism. DDS middleware simplifies a distributed application design by exchanging messages anonymously, and provides a basis on which a well structured program in a modularized form can be implemented. In connection with this, Korean Patent No. 10-1157041 discloses a technology that analyzes information obtained by monitoring the operation of DDS middleware and then controls the QoS parameters of each of DDS applications that constitute communication domains.

Meanwhile, in a DDS implementation, factors related to the performance of a CPS should be taken into consideration. In particular, a CPS requires a memory management means for DDS middleware because performance factors related to memory management have a strong influence on the performance of DDS middleware. However, the DDS standard proposed by the OMG defines only standard interfaces, but does not define the actual implementation of DDS middleware. The conventional technologies for DDS middleware, including that proposed by Korean Patent No. 10-1157041, do not take into consideration a scheme for managing memory for DDS middleware.

### SUMMARY

Accordingly, the present invention has been made keeping in mind the above problems occurring in the prior art, and an object of the present invention is to provide a memory management structure that is suitable for a producer-consumer pattern, that is, the data consumption characteristic of DDS middleware, in a CPS.

Another object of the present invention is to provide a memory management scheme that employs thread heaps configured to manage the entire memory allocated for DDS middleware based on a lock-free technique and to also manage memory allocated to each thread of the DDS middleware, thereby preventing memory contention that may occur between the threads of the DDS middleware and also more efficiently allocating or freeing memory on a memory page basis.

In accordance with an aspect of the present invention, there is provided a memory management apparatus for threads of Data Distribution Service (DDS) middleware, including a memory area management unit configured to partition a memory chunk allocated for the DDS middleware by a Cyber-Physical System (CPS) on a memory page basis, to manage the partitioned memory pages, and to allocate the partitioned memory pages to the threads of the DDS middleware that have requested memory; one or more thread heaps configured to be provided with the memory pages allocated to the threads of the DDS middleware by the memory area management unit, and to manage the provided memory pages; and a queue configured to receive memory pages used by the threads and returned by the thread heaps; wherein the thread heaps are provided with the memory pages for the threads by the queue if a memory page is not present in the memory area management unit when the threads request memory.

The queue may return the memory pages returned by the thread heaps to the memory area management unit when the sum of sizes of all the memory pages returned by the thread heaps is greater than a size of the memory chunk.

The memory area management unit may receive a new memory chunk allocated by the CPS if all memory pages into which the memory chunk have been partitioned are allocated to the threads of the DDS middleware and the returned memory pages are not present in the queue.

The memory area management unit may include a page management unit configured to register and manage the attribute information of the memory pages into which the memory chunk has been partitioned and thread information which is information about the threads to which the memory pages have been allocated.

The attribute information may include one or more of sizes of data objects allocated to the memory page, a number of data objects allocated to the memory page, a number of data objects available to the memory page, and a number of data objects freed from the memory page.

Each of the thread heaps may include a data type management unit configured to classify the memory pages provided by the memory area management unit based on the sizes of the data objects allocated to the memory pages and to manage the classified memory pages.

Each of the thread heaps may determine whether a memory page to which a size of a data object requested by the thread has been allocated is present among the memory pages classified by the data type management unit, and may be provided with the memory page to which the size of the data object requested by the thread has been allocated by the memory area management unit.

When the thread requests the freeing of a specific data object, each of the thread heaps may determine whether all data objects within a memory page to which the specific data object, the freeing of which has been requested, has been allocated have been freed, and may then return the memory page to which the specific data object, the freeing of which has been requested, has been allocated to the queue.

Each of the thread heaps may return the memory page to which the specific data object, the freeing of which has been requested, has been allocated to the queue if all the data objects within the memory page to which the specific data object requested to be freed has been allocated have been freed.

Each of the thread heaps may further include a data object management unit configured to move data objects allocated to a first memory page to a second memory page if a number of data objects less than a critical number are allocated to the first memory page to which the data objects have been allocated.

The data object management unit may move data objects, allocated to the memory page for a period equal to or longer than a critical time or accessed by the thread a number of times less than a critical access number, to another memory page.

In accordance with another aspect of the present invention, there is provided a memory management method for threads of DDS middleware, including being allocated, by a memory area management unit, a memory chunk for the DDS middleware by a CPS; partitioning, by the memory area management unit, the memory chunk on a memory page basis; allocating, by the memory area management unit, the partitioned memory pages to the threads of the DDS middleware that have requested memory, and providing, by the memory area management unit, thread heaps with the memory pages allocated to the threads; returning, by the thread heaps, used memory pages to a queue; determining, by the thread heaps, whether a memory page is present in the memory area management unit when the threads request memory; and being provided, by the thread heaps, with the memory pages for the threads by the queue if the memory page is not present in the memory area management unit.

The memory management method may further include determining, by the queue, whether the sum of sizes of all memory pages returned by the thread heaps is greater than a size of the memory chunk; and returning, by the queue, the memory pages returned by the thread heaps to the memory area management unit if the sum of the sizes of all the memory pages returned by the thread heaps is greater than the size of the memory chunk.

Being allocated the memory chunk for the DDS middleware by the CPS may include being allocated a new memory chunk by the CPS if all memory pages into which the memory chunk has been allocated are allocated to the threads of the DDS middleware and the returned memory pages are not present in the queue.

Providing the thread heaps with the memory pages allocated to the thread may include registering and managing the attribute information of the memory pages into which the memory chunk has been partitioned and thread information which is information about the threads to which the memory pages have been allocated.

The attribute information may include one or more of sizes of data objects allocated to the memory page, a number of data objects allocated to the memory page, a number of data objects available to the memory page, and a number of data objects freed from the memory page.

Returning the used memory page to a queue may include, when the thread requests the freeing of a specific data object, determining whether all data objects within a memory page to which the specific data object, the freeing of which has been requested, has been allocated have been freed, and then returning the memory page to which the specific data object has been allocated to the queue.

Returning the memory page to which the specific data object has been allocated to the queue may include returning the memory page to which the specific data object has been allocated to the queue if all the data objects within the memory page to which the specific data object has been allocated have been freed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a memory management apparatus according to the present invention;

FIG. 2 is a diagram illustrating the configuration and operation of the memory area management unit shown in FIG. 1;

FIG. 3 is a diagram illustrating the configuration and operation of the thread heap shown in FIG. 1;

FIG. 4 is a diagram illustrating the flow of the operation of the memory management apparatus according to the present invention when a thread of DDS middleware requests the allocation of memory;

FIG. 5 is a diagram illustrating the flow of the operation of the memory management apparatus according to the present invention when a thread of DDS middleware requests the freeing of memory;

FIG. 6 is a diagram illustrating a process of allocating and freeing data objects to and from a memory page in the thread heap of FIG. 3;

FIG. 7 is a flowchart illustrating the operation of the data object management unit shown in FIG. 3; and

FIG. 8 is a flowchart illustrating a memory management method according to the present invention.

### DETAILED DESCRIPTION

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

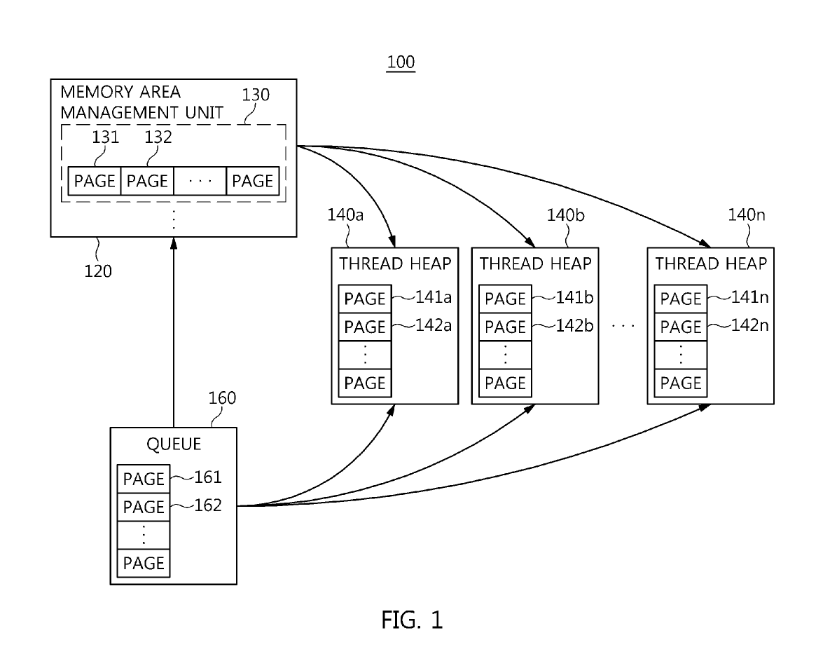

The configuration and operation of a memory management apparatus for the threads of DDS middleware according to the present invention will be described below with reference to FIGS. 1 to 7.

FIG. 1 is a diagram showing the configuration of a memory management apparatus according to the present invention.

Referring to FIG. 1, the memory management apparatus 100 for the threads of DDS middleware according to the present invention includes a memory area management unit 120 configured to be allocated memory to be used in the DDS middleware by the memory of a CPS, and to partition and manage the allocated memory on a memory page basis, one or more thread heaps 140a, 140b, . . . , 140n configured to receive memory pages to be used for the respective threads of the DDS middleware from the memory area management unit 120, and to manage the received memory pages, and a queue 160 configured to receive memory pages used and returned by the threads of the DDS middleware from the thread heaps 140a, 140b, . . . , 140n, and to provide the returned memory pages to the thread heaps 140a, 140b, . . . , 140n so that the returned memory pages can be used again by the threads of the DDS middleware.

The memory area management unit 120 requests the entire memory to be used in the DDS middleware from the internal/external storage devices (not shown) of the CPS on a memory request unit basis, and is allocated the memory. In this case, the memory request unit is a preset chunk unit. The memory area management unit 120 requests a memory chunk 130 having a preset size from the internal/external storage devices of the CPS, and is then allocated the memory chunk 130. Furthermore, the memory area management unit 120 partitions the memory chunk 130 allocated by the internal/external storage devices of the CPS into memory pages 131, 132, . . . , and then allocates the memory pages 131, 132, . . . to the threads of the DDS middleware that have requested memory.

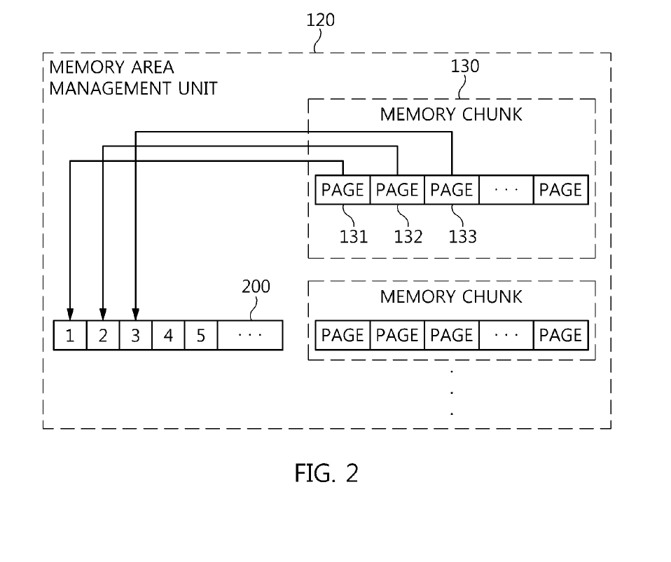

More specifically, referring to FIG. 2, the memory area management unit 120 is configured to manage the entire memory for the DDS middleware, to receive the memory chunk 130 allocated by the internal/external storage devices of the CPS, and to partition the allocated memory chunk 130 into the memory pages 131, 132, 133, . . . to be used by the respective threads of the DDS middleware.

First, the memory area management unit 120 is allocated the memory chunk 130 by the internal/external storage devices of the CPS on a memory chunk basis, that is, on a memory request unit basis. In this case, the memory chunk 130 allocated to the memory area management unit 120 is the contiguous space of memory allocated by the internal/external storage devices of the CPS.

Thereafter, the memory area management unit 120 partitions the allocated memory chunk 130 into small memory units, that is, the memory pages 131, 132, 133, . . . . Each of the memory pages 131, 132, 133, . . . partitioned by the memory area management unit 120 corresponds to unit memory that is used by each thread which is actually executed in the DDS middleware. In this case, the memory pages 131, 132, 133, . . . have the same size, and the size of the memory pages 131, 132, 133, . . . may be set according to the specifications of a system. The memory pages 131, 132, 133, . . . have respective object size attributes. Each of the object size attributes indicates a data size that will be used in a corresponding memory page. For example, the size of a data object that may be allocated to a memory page may range from 4 bytes to 32768 bytes, and may be changed if necessary. If a data object having a size of 4 bytes is set for a specific memory page, the memory page can be used only for a data object having a size of 4 bytes.

Meanwhile, the memory area management unit 120 includes a page management unit 200 configured to register and manage information about the attributes of the memory pages 131, 132, 133, . . . into which the memory chunk 130 has been partitioned and information about threads to which the respective memory pages 131, 132, 133, . . . have been allocated. When a memory request, such as “alloc,” is made by a specific thread of the DDS middleware, the memory area management unit 120 allocates the foremost memory page of the memory pages that are included in the memory chunk 130 and have not been allocated to the threads of the DDS middleware, to the specific thread. In this case, the attribute information of the memory page allocated to the specific thread and thread information is registered with the page management unit 200. The attribute information of the memory page and thread information registered with and managed by the page management unit 200 is used as information that is used to effectively perform a process of setting or freeing a data object in or from the memory page. The attribute information of a memory page registered with and managed by the page management unit 200 may include the size of a data object allocated to the memory page, the number of data objects to be allocated to the memory page, that is, the number obtained by dividing the memory page by the size of the allocated data object, the number of available data objects among the data objects allocated to the memory page, and the number of freed data objects among the data objects allocated to the memory page.

Accordingly, the memory management apparatus 100 for the threads of the DDS middleware according to the present invention may be aware of the size of each memory page and the size of each data object allocated to each memory page, and may calculate the number of data objects allocated to each memory page. Accordingly, the memory management apparatus 100 may perform the allocating and freeing of memory within a memory page more efficiently using the corresponding information with respect to a producer-consumer memory usage pattern.

Meanwhile, if all memory pages into which the memory chunk 130 have been partitioned have been allocated to the threads of the DDS middleware and provided to the thread heaps 140a, 140b, . . . , 140n and no memory pages returned by the thread heaps 140a, 140b, . . . , 140n to the queue 160 are present in the queue 160, the memory area management unit 120 requests a new memory chunk from the internal/external storage devices of the CPS (not shown) and is then allocated the new memory chunk.

The thread heaps 140a, 140b, . . . , 140n are provided in the respective threads of the DDS middleware, and any one of the thread heaps is allocated a memory page allocated to any one of the threads of the DDS middleware by the memory area management unit 120, and manages the allocated memory page. That is, the thread heaps 140a, 140b, . . . , 140n receive the memory pages 141a, 142a, . . . ; 141b, 142b, . . . ; 141n, 142n, . . . to be used in the threads of the DDS middleware from the memory area management unit 120, and manage the received memory pages. The memory management apparatus 100 according to the present invention includes thread heaps for the respective threads of the DDS middleware. Accordingly, each thread uses only a memory page allocated thereto, and thus can provide lock-free memory management that is capable of reducing lock contention that may occur when memory is used between threads.

Meanwhile, the thread heaps 140a, 140b, . . . , 140n return the used memory pages 161, 162, . . . to the queue 160. In this case, the thread heaps 140a, 140b, . . . , 140n have the same configuration and perform the same function on the threads of the DDS middleware. Accordingly, in order to help an understanding of the present invention, only one thread heap 140a will be described below by way of example.

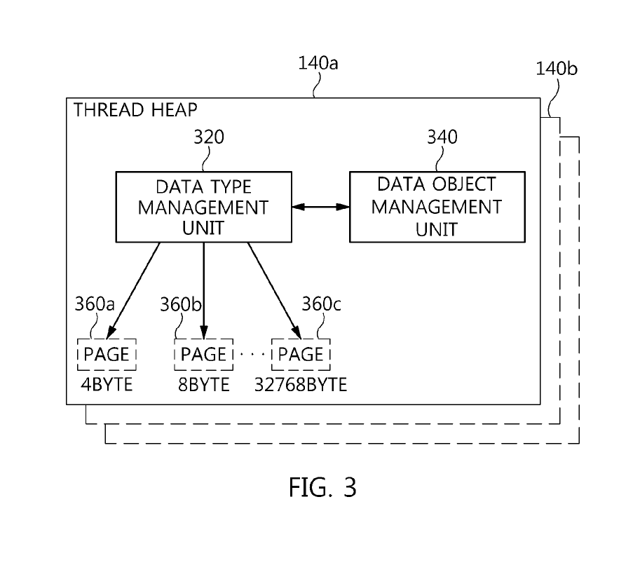

Referring to FIG. 3, the thread heap 140a includes a data type management unit 320 and a data object management unit 340. The data type management unit 320 classifies the memory pages 360a, 360b, . . . , 360c, allocated by the memory area management unit 120 based on the types of data objects to be used by the respective threads of the DDS middleware, based on the sizes of data objects allocated to corresponding memory pages, and manages the classified memory pages. The data object management unit 340 prevents the fragmentation of memory pages.

The data type management unit 320 of the thread heap 140a classifies the memory pages 360a, 360b, . . . , 360c provided by the memory area management unit 120 based on the sizes of respective data objects, and manages the classified memory pages. When a request for memory of a specific size is made by a thread of the DDS middleware, the data type management unit 320 allocates a data object from a memory page, which belongs to the managed memory pages 360a, 360b, . . . , 360c and for which the size of a data object corresponding to the size of the memory requested by the thread has been set, to the thread, and returns the data object. FIG. 3 illustrates that the memory pages 360a, 360b, and 360c for respective data objects of 4 byte, 8 byte and 32768 byte sizes are managed by the data type management unit 320.

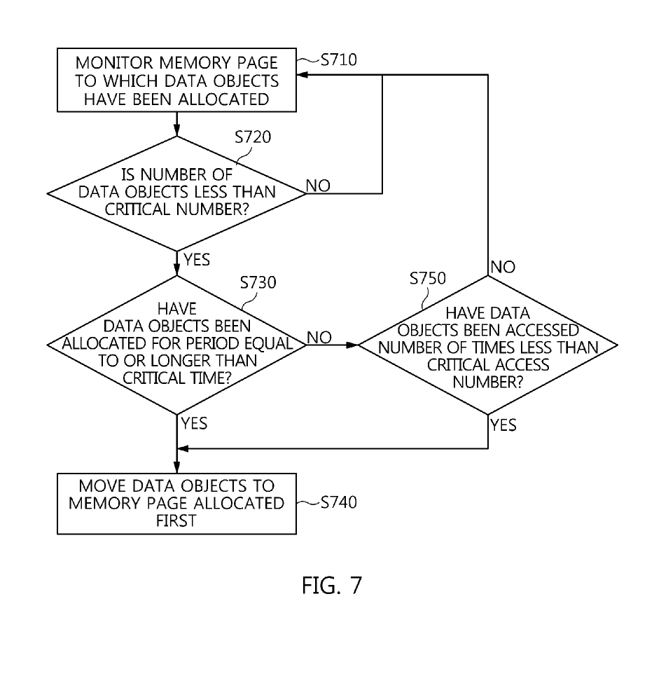

Meanwhile, if a memory page not allocated to a thread is not present in the memory area management unit 120 when a thread requests memory, the thread heap 140a receives a memory page for the thread from the queue 160. The data object management unit 340 is a means for preventing the fragmentation of memory pages, and will be described later with reference to FIG. 7.

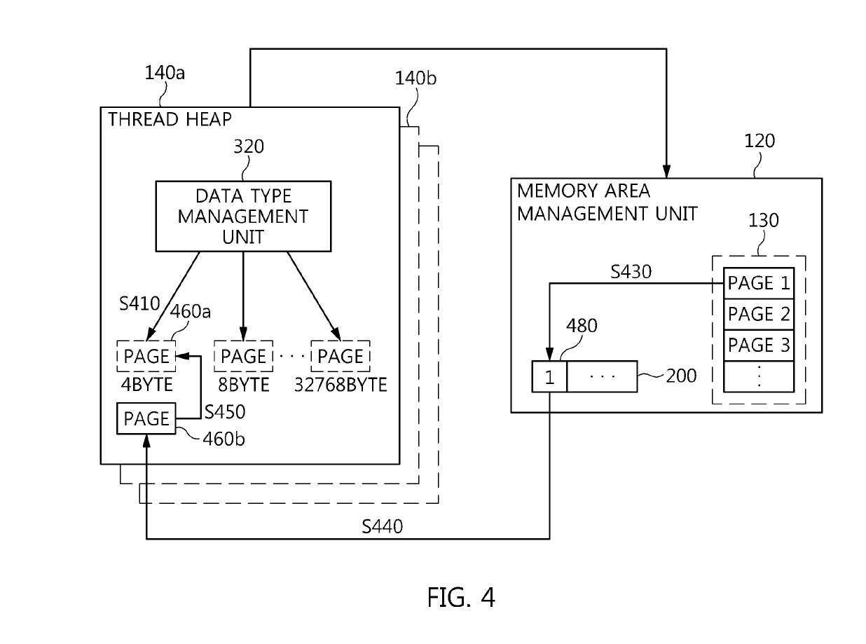

FIG. 4 is a diagram illustrating the flow of the operation of the memory management apparatus 100 according to the present invention when any one thread of the DDS middleware requests the allocation of memory from the memory management apparatus 100.

Referring to FIG. 4, when any one thread of the DDS middleware requests memory having a size of 4 bytes from the memory management apparatus 100 via “alloc,” the thread heap 140a first determines whether a memory page 460a to which the size of 4 bytes requested by the thread has been allocated is present among memory pages classified by the data type management unit 320 at step S410.

If, as a result of the determination, it is determined that the memory page 460a to which the size of 4 bytes requested by the thread has been allocated is present, the thread heap 140a allocates the memory having the size of 4 bytes from the memory page 460a to which the size of 4 bytes has been allocated to the thread. In contrast, if, as a result of the determination, it is determined that the memory page 460a to which the size of 4 bytes has been allocated is not present, the thread heap 140a requests a memory page, which has not been allocated to a thread of the DDS middleware and has an object data size of 4 bytes, from the memory area management unit 120 at step S420.

In response to the memory page request of the thread heap 140a, the memory area management unit 120 registers the attribute information of the memory page, which has not been allocated to a thread of the DDS middleware and has an object data size of 4 bytes, and thread information with the page management unit 200 (480) at step S430, and provides a corresponding memory page 460b to the thread heap 140a at step S440. In this case, the data type management unit 320 of the thread heap 140a registers and manages the memory page 460b received from the memory area management unit 120 at step S450. The thread heap 140a allocates the memory page 460b to the thread.

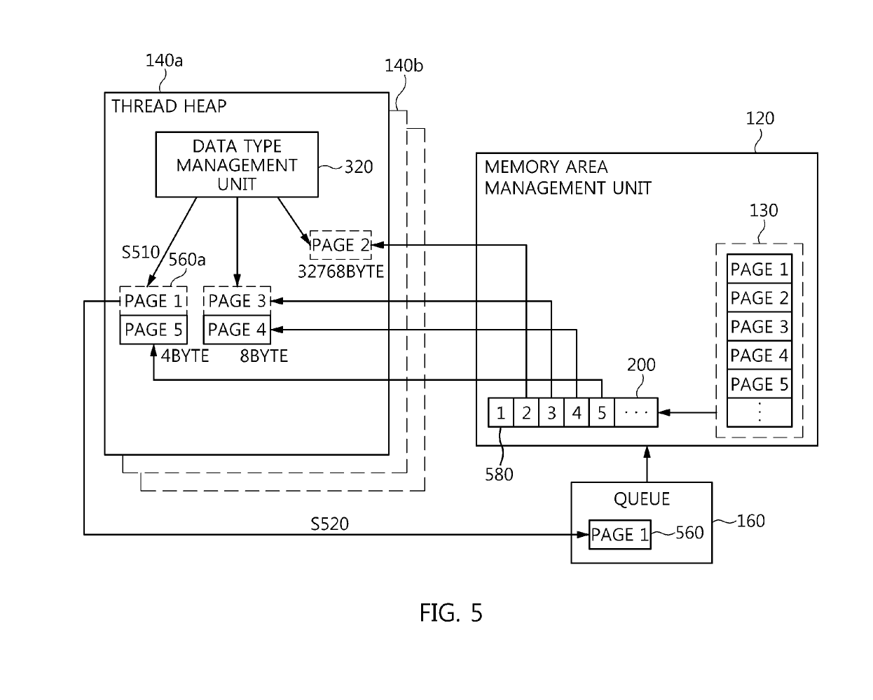

FIG. 5 is a diagram illustrating the flow of the operation of the memory management apparatus 100 according to the present invention when any one thread of DDS middleware requests the freeing of memory from the memory management apparatus 100.

Referring to FIG. 5, when any one thread of the DDS middleware requests the memory management apparatus 100 to free a data object having a size of 4 bytes, the thread heap 140a determines whether all data objects within the memory page 560a to which the data object, the freeing of which has been requested by the thread, has been allocated have been freed via the data type management unit 320 at step S510.

If, as a result of the determination, it is determined that all the data objects within the memory page 560a to which the data object requested to be freed by the thread has been allocated have been freed, the thread heap 140a returns the memory page 560a to which the data object, the freeing of which has been requested by the thread, has been allocated to the queue 160 at step S520, and thus the used memory page 560a can be used again. In this case, the memory area management unit 120 deletes the attribute information of the memory page 560a and the thread information registered with the page management unit 200 which manages the memory page 560a (580).

The queue 160 receives memory pages used and returned by the thread heaps 140a, 140b, . . . , 140n. If a memory page not allocated to the memory area management unit 120 is present when a thread requests memory, the queue 160 provides a returned memory page to a thread heap that manages the memory page for the thread so that the returned memory page is used again. That is, the queue 160 manages the memory pages returned by the thread heaps 140a, 140b, . . . , 140n so that the memory pages are used again. Accordingly, if no available memory pages are present in the memory area management unit 120 when a thread requests memory, the thread heaps 140a, 140b, . . . , 140n are provided with the memory pages returned to the queue 160 instead.

Meanwhile, if the sum of the sizes of all the memory pages returned by the thread heaps 140a, 140b, . . . , 140n is greater than a preset threshold, the queue 160 returns the memory pages returned by the thread heaps 140a, 140b, . . . , 140n to the memory area management unit 120, thereby minimizing the use of the memory of the CPS. The preset threshold may be the size of a memory chunk allocated the memory area management unit 120, but is not limited thereto.

Furthermore, if the sum of the sizes of all the memory pages returned by the thread heaps 140a, 140b, . . . , 140n is greater than a preset threshold, the queue 160 may return memory pages corresponding to a size above the preset threshold to the memory area management unit 120, or may return all the memory pages returned by the thread heaps 140a, 140b, . . . , 140n to the memory area management unit 120.

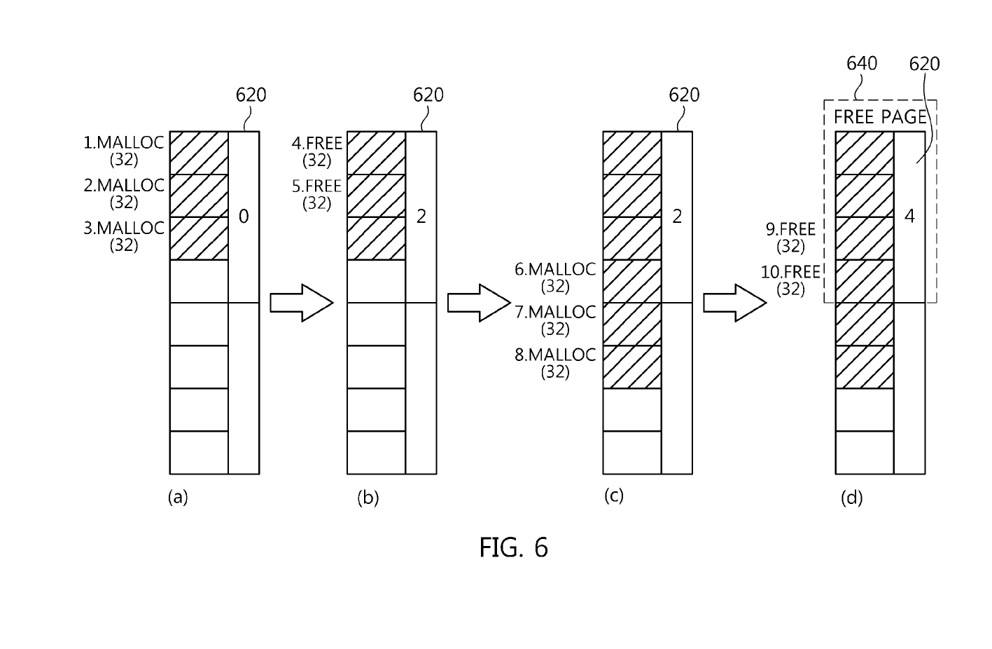

FIG. 6 is a diagram illustrating a process of allocating and freeing data objects to and from a memory page in the thread heap of FIG. 3. In the present invention, in order to be optimized for a producer-consumer memory usage pattern, it is assumed that data objects allocated to a memory page are not used again even when the data objects are freed. It is also assumed that freed data objects are not immediately returned. If all the data objects of a memory page are freed, the memory page is returned to the queue 160, and data objects are newly allocated in the memory page that is returned to the queue 160 and is then provided to the thread heap.

Referring to FIG. 6, when a thread of the DDS middleware requests the allocation of data objects to a memory page, the data objects are successively allocated to the memory page. Thereafter, when the thread requests the freeing of the data objects allocated to the memory page, the data objects are not immediately freed, but only the number of data objects freed from the memory page is counted (620). As described above, according to the present invention, since the size of a memory page in the memory area management unit 120, the size of data objects allocated to the memory page, and the number of data objects can be calculated, the allocation and freeing of memory suitable for a producer-consumer memory usage pattern can be performed.

FIG. 6 illustrates a case where a single memory page includes four 32-byte data objects. When the thread requests the allocation of memory for a No. 3 data object (in the case of FIG. 6(a)), the value of the free counter 620 of the memory page becomes 0. Thereafter, when the thread requests the freeing of memory for a No. 2 data object (in the case of FIG. 6(b)), the value of the free counter 620 becomes 2, the data objects within the memory page are not actually freed, and the memory page is not freed because the memory for the four data objects has not been freed. Thereafter, when the thread further requests the allocation of memory for a No. 3 data object (in the case of FIG. 6(c)), the value of the free counter 620 continues to remain 2 because freed memory is not present. Thereafter, when the thread further requests the freeing of memory for the No. 2 data object (in the case of FIG. 6(d)), the value of the free counter 620 becomes 4 and, the memory page 640 is returned to the queue 160 and then used again because the memory for the four data objects has been freed.

According to the present invention, the allocation and freeing of memory are effectively performed in accordance with a producer-consumer memory usage pattern. However, as described with reference to FIG. 6, if one data object remains in a specific memory page, the amount of memory used may increase because the entire memory page may not be used. In order to solve such a memory page fragmentation problem, the thread heap 140a includes the data object management unit 340, such as that shown in FIG. 3.

Referring to FIG. 7, the data object management unit 340 of the thread heap 140a monitors a memory page to which data objects have been allocated at step S710, and determines whether the number of data objects allocated to the memory page is less than a critical number at step S720. If, as a result of the determination, it is determined that the number of data objects allocated to the memory page is less than the critical number, the data object management unit 340 determines whether the data objects have been allocated to the memory page for a period equal to or longer than a critical time at step S730. If, as a result of the determination at step S730, it is determined that the data objects have been allocated to the memory page for the period equal to or longer than the critical time, the data object management unit 340 moves the data objects to a memory page to which data objects having the same size have been allocated and which has been allocated to a thread first and provided to the thread heap 140a at step S740.

Meanwhile, if, as a result of the determination at step S730, it is determined that the data objects have not been allocated to the memory page for the period equal to or longer than the critical time, the data object management unit 340 determines whether the data objects have been accessed by the thread a number of times less than a critical access number at step S750. If, as a result of the determination at step S750, it is determined that the data objects have been accessed by the thread the number of times less than the critical access number, the data object management unit 340 moves the data objects to a memory page to which data objects having the same size have been allocated and which has been allocated to a thread first and provided to the thread heap 140a at step S740.

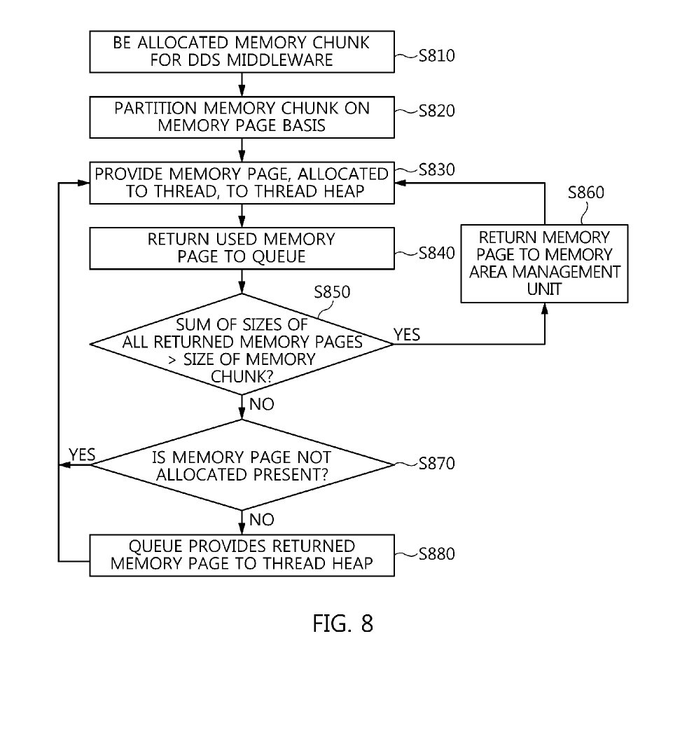

According to the present invention, a memory management method for the threads of the DDS middleware will be described below with reference to FIG. 8. Descriptions that are identical to those of the operation of the memory management apparatus for the threads of the DDS middleware according to the present invention given with reference to FIGS. 1 to 7 will be omitted.

FIG. 8 is a flowchart illustrating the memory management method for the threads of DDS middleware according to the present invention.

Referring to FIG. 8, in the memory management method for the thread of DDS middleware according to the present invention, first, the memory area management unit 120 is allocated a memory chunk for the entire memory to be used in the DDS middleware by the internal/external storage devices of the CPS at step S810, and partitions the memory chunk allocated by the internal/external storage devices of the CPS on a memory page basis at step S820. Meanwhile, if all the partitioned memory pages of the memory chunk have been allocated to the threads of the DDS middleware and a memory page returned to the queue 160 is not present, the memory area management unit 120 may request a new memory chunk from the internal/external storage devices of the CPS and then receive the requested memory chunk at step S810.

Thereafter, the memory area management unit 120 allocates the memory pages partitioned at step S820 to the threads of the DDS middleware and provides a corresponding one of the memory pages allocated to the threads to the thread heap 140a corresponding to the corresponding thread at step S830. At step S830, the memory area management unit 120 may register the attribute information of the memory page that has been partitioned off from the memory chunk and thread information that is information about the thread to which the memory page have been allocated, with the page management unit 200. In this case, the attribute information of the memory page registered with and managed by the page management unit 200 may include one or more of the sizes of data objects allocated to a memory page, the number of data objects allocated to the memory page, the number of data objects available to the memory page, and the number of data objects freed from the memory page.

Thereafter, the thread heap 140a returns a used memory page among the memory pages allocated by the memory area management unit 120 to the queue 160 at step S840. In this case, when the thread requests the freeing of memory for a specific data object, the thread heap 140a determines whether memory for all data objects within a memory page to which the data object, the freeing of which has been requested by the thread, has been allocated has been freed. If, as a result of the determination, it is determined that the memory for all data objects within a memory page to which the data object, the freeing of which has been requested by the thread, has been allocated has been freed, the thread heap 140a returns the memory page to the queue 160.

Meanwhile, the queue 160 determines whether the sum of the sizes of all the memory pages returned by the thread heaps 140a, 140b, . . . , 140n is greater than a memory chunk at step S850. If, as a result of the determination, it is determined that the sum of the sizes of all the memory pages returned by the thread heaps 140a, 140b, . . . , 140n is greater than a memory chunk, the queue 160 returns the memory pages returned by the thread heaps 140a, 140b, . . . , 140n to the memory area management unit 120 in order to minimize the user of memory at step S860. In this case, the queue 160 may return memory pages corresponding to a size above the size of a memory chunk to the memory area management unit 120, or may return all memory pages returned by the thread heaps 140a, 140b, . . . , 140n to the memory area management unit 120.

Thereafter, when the thread requests additional memory, the thread heap 140a determines whether a memory page not allocated is present in the memory area management unit 120 at step S870. If, as a result of the determination, it is determined that a memory page not allocated is present in the memory area management unit 120, the thread heap 140a is provided with a memory page allocated to the thread by the memory area management unit 120 at step S830. In contrast, if, as a result of the determination, it is determined that a memory page not allocated is not present in the memory area management unit 120, the thread heap 140a is provided with a memory page for the thread by the queue 160 at step S880.

Meanwhile, the memory management method for the threads of DDS middleware according to the present invention may be implemented in the form of program instructions that can be executed by various computer means, and may be recorded on a computer-readable recording medium. The computer-readable recording medium may restore program instructions, data files, and data structures solely or in combination. The program instructions recorded on the recording medium may have been specially designed and configured for the present invention, or may be known to or available to those who have ordinary knowledge in the field of computer software. Examples of the computer-readable recording medium include all types of hardware devices specially configured to record and execute program instructions, such as magnetic media, such as a hard disk, a floppy disk, and magnetic tape, optical media, such as CD-ROM and a DVD, magneto-optical media, such as a floptical disk, ROM, RAM, and flash memory. Examples of the program instructions include machine code, such as code created by a compiler, and high-level language code executable by a computer using an interpreter.

The present invention is advantageous in that a CPS can provide a memory management structure that is suitable for a producer-consumer pattern, that is, the data consumption characteristic of DDS middleware.

Furthermore, the present invention is advantageous in that it can provide a memory management scheme for preventing memory contention that may occur between the threads of DDS middleware and more efficiently allocating or freeing memory on a memory page basis using thread heaps configured to manage the entire memory allocated to the DDS middleware based on lock-free technique and to also manage memory allocated to each thread of the DDS middleware.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A memory management apparatus for threads of Data Distribution Service (DDS) middleware, comprising:
a memory area management unit configured to partition a memory chunk allocated for the DDS middleware by a Cyber-Physical System (CPS) on a memory page basis, to manage the partitioned memory pages, and to allocate the partitioned memory pages to the threads of the DDS middleware that have requested memory;
one or more thread heaps configured to be provided with the memory pages allocated to the threads of the DDS middleware by the memory area management unit, and to manage the provided memory pages; and
a queue configured to receive memory pages used by the threads and returned by the thread heaps;
wherein the thread heaps are provided with the memory pages for the threads by the queue if a memory page is not present in the memory area management unit when the threads request memory.

2. The memory management apparatus of claim 1, wherein the queue returns the memory pages returned by the thread heaps to the memory area management unit when a sum of sizes of all the memory pages returned by the thread heaps is greater than a size of the memory chunk.

3. The memory management apparatus of claim 2, wherein the memory area management unit receives a new memory chunk allocated by the CPS if all memory pages into which the memory chunk have been partitioned are allocated to the threads of the DDS middleware and the returned memory pages are not present in the queue.

4. The memory management apparatus of claim 3, wherein the memory area management unit comprises a page management unit configured to register and manage attribute information of the memory pages into which the memory chunk has been partitioned and thread information which is information about the threads to which the memory pages have been allocated.

5. The memory management apparatus of claim 4, wherein the attribute information comprises one or more of sizes of data objects allocated to the memory page, a number of data objects allocated to the memory page, a number of data objects available to the memory page, and a number of data objects freed from the memory page.

6. The memory management apparatus of claim 5, wherein each of the thread heaps comprises a data type management unit configured to classify the memory pages provided by the memory area management unit based on the sizes of the data objects allocated to the memory pages and to manage the classified memory pages.

7. The memory management apparatus of claim 6, wherein each of the thread heaps determines whether a memory page to which a size of a data object requested by the thread has been allocated is present in the memory pages classified by the data type management unit, and is provided with the memory page to which the size of the data object requested by the thread has been allocated by the memory area management unit.

8. The memory management apparatus of claim 6, wherein each of the thread heaps, when the thread requests freeing of a specific data object, determines whether all data objects within a memory page to which the specific data object, the freeing of which has been requested, has been allocated have been freed, and then returns the memory page to which the specific data object, the freeing of which has been requested, has been allocated to the queue.

9. The memory management apparatus of claim 8, wherein each of the thread heaps returns the memory page to which the specific data object, the freeing of which has been requested, has been allocated to the queue if all the data objects within the memory page to which the specific data object requested to be freed has been allocated have been freed.

10. The memory management apparatus of claim 9, wherein each of the thread heaps further comprises a data object management unit configured to move data objects allocated to a first memory page to a second memory page if a number of data objects less than a critical number are allocated to the first memory page to which the data objects have been allocated.

11. The memory management apparatus of claim 10, wherein the data object management unit moves data objects, allocated to the memory page for a period equal to or longer than a critical time or accessed by the thread a number of times less than a critical access number, to another memory page.

12. A memory management method for threads of DDS middleware, comprising:
being allocated, by a memory area management unit, a memory chunk for the DDS middleware by a CPS;
partitioning, by the memory area management unit, the memory chunk on a memory page basis;
allocating, by the memory area management unit, the partitioned memory pages to the threads of the DDS middleware that have requested memory, and providing, by the memory area management unit, thread heaps with the memory pages allocated to the threads;
returning, by the thread heaps, used memory pages to a queue;
determining, by the thread heaps, whether a memory page is present in the memory area management unit when the threads request memory; and
being provided, by the thread heaps, with the memory pages for the threads by the queue if the memory page is not present in the memory area management unit.

13. The memory management method of claim 12, further comprising:
determining, by the queue, whether a sum of sizes of all memory pages returned by the thread heaps is greater than a size of the memory chunk; and
returning, by the queue, the memory pages returned by the thread heaps to the memory area management unit if the sum of the sizes of all the memory pages returned by the thread heaps is greater than the size of the memory chunk.

14. The memory management method of claim 13, wherein being allocated the memory chunk for the DDS middleware by the CPS comprises being allocated a new memory chunk by the CPS if all memory pages into which the memory chunk has been allocated are allocated to the threads of the DDS middleware and the returned memory pages are not present in the queue.

15. The memory management method of claim 14, wherein providing the thread heap with the memory pages allocated to the thread comprises registering and managing attribute information of the memory pages into which the memory chunk has been partitioned and thread information which is information about the threads to which the memory pages have been allocated.

16. The memory management method of claim 15, wherein the attribute information comprises one or more of sizes of data objects allocated to the memory page, a number of data objects allocated to the memory page, a number of data objects available to the memory page, and a number of data objects freed from the memory page.

17. The memory management method of claim 16, wherein returning the used memory page to a queue comprises, when the thread requests freeing of a specific data object, determining whether all data objects within a memory page to which the specific data object, the freeing of which has been requested, has been allocated have been freed, and then returning the memory page to which the specific data object has been allocated to the queue.

18. The memory management method of claim 17, wherein returning the memory page to which the specific data object has been allocated to the queue comprises returning the memory page to which the specific data object has been allocated to the queue if all the data objects within the memory page to which the specific data object has been allocated have been freed.
